(19) United States
(12) Patent Application Publication
(10) Pub. No.: US 2013/0016198 A1
(43) Pub. Date: Jan. 17, 2013

(54) IMAGE PROCESSING DEVICE, ENDOSCOPE APPARATUS, INFORMATION STORAGE DEVICE, AND IMAGE PROCESSING METHOD

(71) Applicants: Keiji Higuchi, Tokyo (JP); Naoya Kuriyama, Tokyo (JP)

(72) Inventors: Keiji Higuchi, Tokyo (JP); Naoya Kuriyama, Tokyo (JP)

(73) Assignee: OLYMPUS CORPORATION, Tokyo (JP)

(21) Appl. No.: 13/545,397

(22) Filed: Jul. 10, 2012

(30) Foreign Application Priority Data
Jul. 11, 2011 (JP) 2011-153131

(51) Int. Cl. H04N 7/18

(52) U.S. Cl. 348/65; 348/E07.085

(57) ABSTRACT

An image processing device includes an image signal acquisition section that acquires image signals that include signals of an object image from an image sensor, the image sensor being configured so that the object image is formed in an imaging area via an optical system, and is not formed in a non-imaging area, a processing target area setting section that sets a processing target area to an image of an image signal acquired area so that the processing target area is included in the imaging area, the image signal acquired area being an area in which the image signals have been acquired, and the processing target area including pixels used for a grayscale transformation process, and a grayscale transformation section that performs the grayscale transformation process based on pixel values of the pixels included in the processing target area.

Japanese Patent Application No. 2011-153131 filed on Jul. 11, 2011, is hereby incorporated by reference in its entirety.

### BACKGROUND

The present invention relates to an image processing device, an endoscope apparatus, an information storage device, an image processing method, and the like.

An image processing device acquires image signals when light that has passed through a lens forms an image on an image sensor, performs given image processing on the image signals to generate an image, and outputs the image to a display or the like. An area in which an image is formed by the lens (hereinafter referred to as “imaging area”) does not necessarily coincide with an area in which image signals are obtained by the image sensor (hereinafter referred to as “image signal acquired area”).

The pixel values of an area that is included in the image signal acquired area, but is not included in the imaging area are not obtained from the image, but contain useless data (e.g., noise). Therefore, a mask area may be set within the image signal acquired area in advance, and a masking process that fills in the mask area may be performed on the acquired image to output the final image. For example, JP-A-2003-070735 discloses a method wherein an electronic scope generates a mask signal, and a masking process is performed on signals obtained by image processing.

### SUMMARY

According to one aspect of the invention, there is provided an image processing device comprising:

an image signal acquisition section that acquires image signals that include signals of an object image from an image sensor, the image sensor being configured so that the object image is formed in an imaging area via an optical system, and is not formed in a non-imaging area;

a processing target area setting section that sets a processing target area to an image of an image signal acquired area so that the processing target area is included in the imaging area, the image signal acquired area being an area in which the image signals have been acquired, and the processing target area including pixels used for a grayscale transformation process; and

a grayscale transformation section that performs the grayscale transformation process based on pixel values of the pixels included in the processing target area.

According to another aspect of the invention, there is provided an endoscope apparatus comprising:

an image signal acquisition section that acquires image signals that include signals of an object image from an image sensor, the image sensor being configured so that the object image is formed in an imaging area via an optical system, and is not formed in a non-imaging area;

a processing target area setting section that sets a processing target area to an image of an image signal acquired area so that the processing target area is included in the imaging area, the image signal acquired area being an area in which the image signals have been acquired, and the processing target area including pixels used for a grayscale transformation process; and

a grayscale transformation section that performs the grayscale transformation process based on pixel values of the pixels included in the processing target area.

According to another aspect of the invention, there is provided an information storage device storing a program that causes a computer to function as:

an image signal acquisition section that acquires image signals that include signals of an object image from an image sensor, the image sensor being configured so that the object image is formed in an imaging area via an optical system, and is not formed in a non-imaging area;

a processing target area setting section that sets a processing target area to an image of an image signal acquired area so that the processing target area is included in the imaging area, the image signal acquired area being an area in which the image signals have been acquired, and the processing target area including pixels used for a grayscale transformation process; and

a grayscale transformation section that performs the grayscale transformation process based on pixel values of the pixels included in the processing target area.

According to another aspect of the invention, there is provided an image processing method comprising:

acquiring image signals that include signals of an object image from an image sensor, the image sensor being configured so that the object image is formed in an imaging area via an optical system, and is not formed in a non-imaging area;

setting a processing target area to an image of an image signal acquired area so that the processing target area is included in the imaging area, the image signal acquired area being an area in which the image signals have been acquired, and the processing target area including pixels used for a grayscale transformation process; and

performing the grayscale transformation process based on pixel values of the pixels included in the processing target area.

### BRIEF DESCRIPTION OF THE DRAWINGS

FIG. 1 illustrates a system configuration example according to a first embodiment.

FIGS. 2A to 2D are views illustrating an imaging area, an image signal acquired area, and an object image area.

FIGS. 3A to 3D are views illustrating a processing target area, a mask area, and a display area.

FIG. 4 is a view illustrating a method that sets a processing target area using section information.

FIG. 5 is a flowchart illustrating image processing according to several embodiments of the invention.

FIG. 6 illustrates a system configuration example according to a second embodiment.

FIG. 7 is a view illustrating a method that sets a processing target area using polar coordinates.

FIGS. 8A to 8C are views illustrating an imaging area and an image signal acquired area according to the second embodiment.

FIGS. 9A to 9D are views illustrating a processing target area, a mask area, and a display area according to the second embodiment.

FIGS. 10A and 10B are views illustrating a blind spot that occurs due to a tube.

FIGS. 11A and 11B are views illustrating a related-art grayscale transformation process, and FIGS. 11C and 11D are views illustrating a grayscale transformation process according to several embodiments of the invention.

FIG. 12 illustrates a system configuration example according to a third embodiment.

FIG. 13A to 13C are views illustrating a method that sets a processing target area using a reference image.

FIG. 14 is a view illustrating a front area, a side area, and a rear area.

### DESCRIPTION OF EXEMPLARY EMBODIMENTS

According to one embodiment of the invention, there is provided an image processing device comprising:

an image signal acquisition section that acquires image signals that include signals of an object image from an image sensor, the image sensor being configured so that the object image is formed in an imaging area via an optical system, and is not formed in a non-imaging area;

a processing target area setting section that sets a processing target area to an image of an image signal acquired area so that the processing target area is included in the imaging area, the image signal acquired area being an area in which the image signals have been acquired, and the processing target area including pixels used for a grayscale transformation process; and

a grayscale transformation section that performs the grayscale transformation process based on pixel values of the pixels included in the processing target area.

According to another embodiment of the invention, there is provided an endoscope apparatus comprising:

an image signal acquisition section that acquires image signals that include signals of an object image from an image sensor, the image sensor being configured so that the object image is formed in an imaging area via an optical system, and is not formed in a non-imaging area;

a processing target area setting section that sets a processing target area to an image of an image signal acquired area so that the processing target area is included in the imaging area, the image signal acquired area being an area in which the image signals have been acquired, and the processing target area including pixels used for a grayscale transformation process; and

a grayscale transformation section that performs the grayscale transformation process based on pixel values of the pixels included in the processing target area.

According to another embodiment of the invention, there is provided an information storage device storing a program that causes a computer to function as:

an image signal acquisition section that acquires image signals that include signals of an object image from an image sensor, the image sensor being configured so that the object image is formed in an imaging area via an optical system, and is not formed in a non-imaging area;

a processing target area setting section that sets a processing target area to an image of an image signal acquired area so that the processing target area is included in the imaging area, the image signal acquired area being an area in which the image signals have been acquired, and the processing target area including pixels used for a grayscale transformation process; and

a grayscale transformation section that performs the grayscale transformation process based on pixel values of the pixels included in the processing target area.

According to another embodiment of the invention, there is provided an image processing method comprising:

acquiring image signals that include signals of an object image from an image sensor, the image sensor being configured so that the object image is formed in an imaging area via an optical system, and is not formed in a non-imaging area;

setting a processing target area to an image of an image signal acquired area so that the processing target area is included in the imaging area, the image signal acquired area being an area in which the image signals have been acquired, and the processing target area including pixels used for a grayscale transformation process; and

performing the grayscale transformation process based on pixel values of the pixels included in the processing target area.

Exemplary embodiments of the invention are described below. Note that the following exemplary embodiments do not in any way limit the scope of the invention laid out in the claims. Note also that all elements of the following exemplary embodiments should not necessarily be taken as essential elements of the invention.

### 1. Method

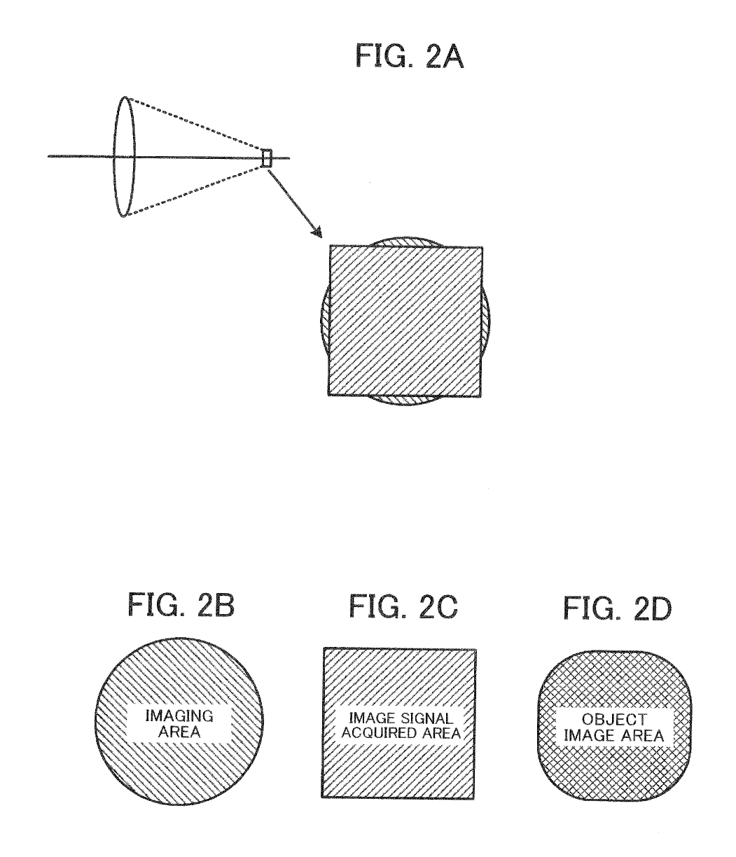

A method employed in several embodiments of the invention is described below. An image processing device acquires image signals when light that has passed through a lens forms an image on an image sensor (see FIG. 2A). However, while light that has passed through the lens forms an image in a circular area (hereinafter referred to as “imaging area”) taking account of the shape of the lens, the image sensor normally has a rectangular shape (a rectangular area that corresponds to the image sensor is hereinafter referred to as “image signal acquired area”).

When the shape of the imaging area does not coincide with the shape of the image signal acquired area, the image signals normally include an area that is included in the imaging area, but is not included in the image signal acquired area, and an area that is included in the image signal acquired area, but is not included in the imaging area. Since the image signals that form an image are acquired based on the signal that corresponds to each pixel of the image sensor, the image signals are acquired corresponding to the image signal acquired area.

Specifically, an area that is included in the imaging area, but is not included in the image signal acquired area does not contribute to the image signals since the image sensor does not have corresponding pixels even if light that forms the object image is incident. On the other hand, the image signals are acquired in an area that is included in the image signal acquired area, but is not included in the imaging area (hereinafter referred to as “non-imaging area”) although light that forms the object image is not incident. Note that the non-imaging area may be the entirety of an area that is not included in the imaging area. Therefore, useless data (e.g., a dark (small) pixel value due to the absence of light, or a pixel value based on noise) is acquired in an area that is included in the image signal acquired area, but is not included in the imaging area.

Therefore, while useful data that reflects the information about the object image is acquired in an area that is included in the imaging area and the image signal acquired area (hereinafter referred to as “object image area” (see FIG. 2D)), useless data is acquired in the non-imaging area. A problem may occur when image processing is performed without distinguishing the useful data from the useless data.

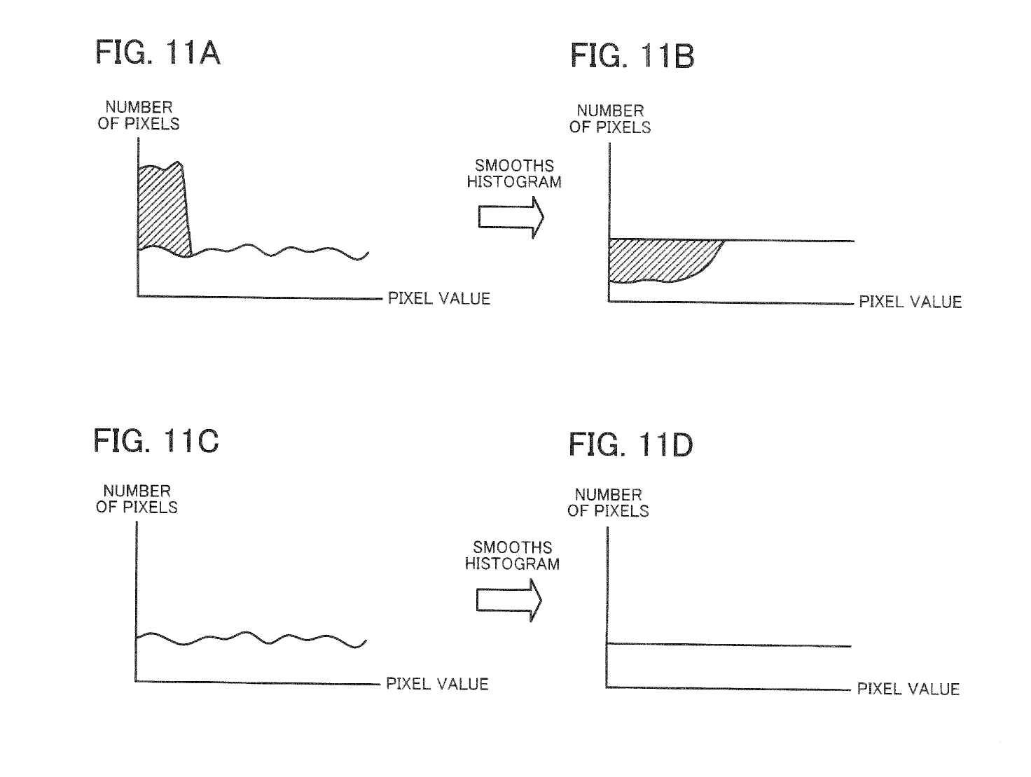

For example, a grayscale transformation process corrects uneven brightness taking account of the brightness (e.g., pixel values or luminance) of the entire image (see FIGS. 11A and 11B). More specifically, the grayscale transformation process increases the brightness of the entire image when the image includes a large number of dark pixels, and decreases the brightness of the entire image when the image includes a large number of bright pixels. It is considered that a dark image is obtained in the non-imaging area since light that has passed through the lens is not incident. Therefore, even if the brightness of the useful data that corresponds to the object image area is not too low, the brightness of the entire image is increased taking account of the low brightness of the useless data. In this case, blown out highlights may occur in the area that includes the useful data, for example.

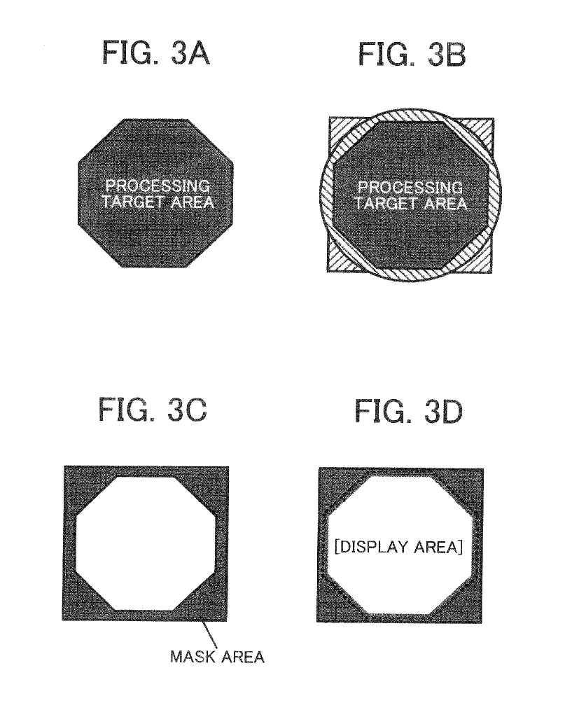

Several aspects of the invention propose a method that sets a processing target area that is included in the object image area (see FIGS. 3A and 3B), and performs the grayscale transformation process using the pixel values of the pixels that are included in the processing target area without using the pixel values of the pixels that are included in the image signal acquired area, but are not included in the processing target area. Specifically, a situation in which useless data adversely affects the grayscale transformation process is prevented by utilizing only useful data (i.e., data that reflects the information about the object image) without using useless data.

A first embodiment and a second embodiment illustrate an example in which data of the processing target area is provided in advance. More specifically, the first embodiment illustrates an example in which the information about the processing target area is stored using a run-length encoding method, and the second embodiment illustrates an example in which the information about the processing target area is stored using polar coordinates when implementing a super-wide-angle endoscope apparatus. A third embodiment illustrates an example in which the processing target area is acquired from a reference image.

### 2. First Embodiment

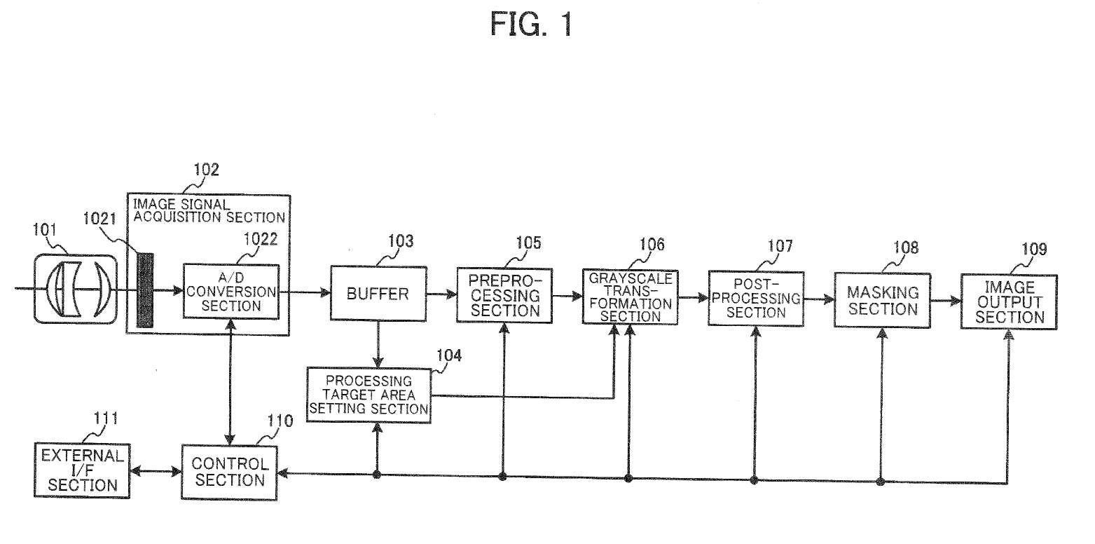

FIG. 1 illustrates an image processing device according to the first embodiment. The image processing device includes an optical system 101, an image signal acquisition section 102, a buffer 103, a processing target area setting section 104, a preprocessing section 105, a grayscale transformation section 106, a post-processing section 107, a masking section 108, an image output section 109, a control section 110, and an external I/F section 111. Note that the configuration of the image processing device is not limited thereto. Various modifications may be made, such as omitting some of these elements.

The image signal acquisition section 102 includes an image sensor 1021 and an A/D conversion section 1022. The A/D conversion section 1022 converts an analog signal acquired via the optical system 101 and the image sensor 1021 into a digital signal. The A/D conversion section 1022 is connected to the buffer 103. The buffer 103 is connected to the preprocessing section 105. The processing target area setting section 104 is connected to the grayscale transformation section 106. The preprocessing section 105 is connected to the grayscale transformation section 106. The grayscale transformation section 106 is connected to the post-processing section 107. The post-processing section 107 is connected to the masking section 108. The masking section 108 is connected to the image output section 109.

The control section 110 (e.g., microcomputer) is bidirectionally connected to the A/D conversion section 1022, the processing target area setting section 104, the preprocessing section 105, the grayscale transformation section 106, the post-processing section 107, the masking section 108, and the image output section 109.

The external I/F section 111 that includes a power switch and a variable setting interface is also bidirectionally connected to the control section 110. The imaging conditions (e.g., imaging size) are set via the external I/F section 111.

Reflected light from the object is condensed by the optical system 101, and an image is formed on the image sensor 1021 in which color filters that respectively allow R, G, or B light to pass through are disposed in a Bayer array (see FIG. 2A). The image sensor 1021 performs a photoelectric conversion process to acquire an analog signal.

The AID conversion section 1022 converts the analog signal into a digital signal, and stores the digital signal in the buffer 103 as an image signal. An area in which the image signals are acquired is referred to as “image signal acquired area” (see FIG. 2C). The preprocessing section 105 reads the image signals stored in the buffer 103, and performs image processing (e.g., black level adjustment and gain control) on the image signals.

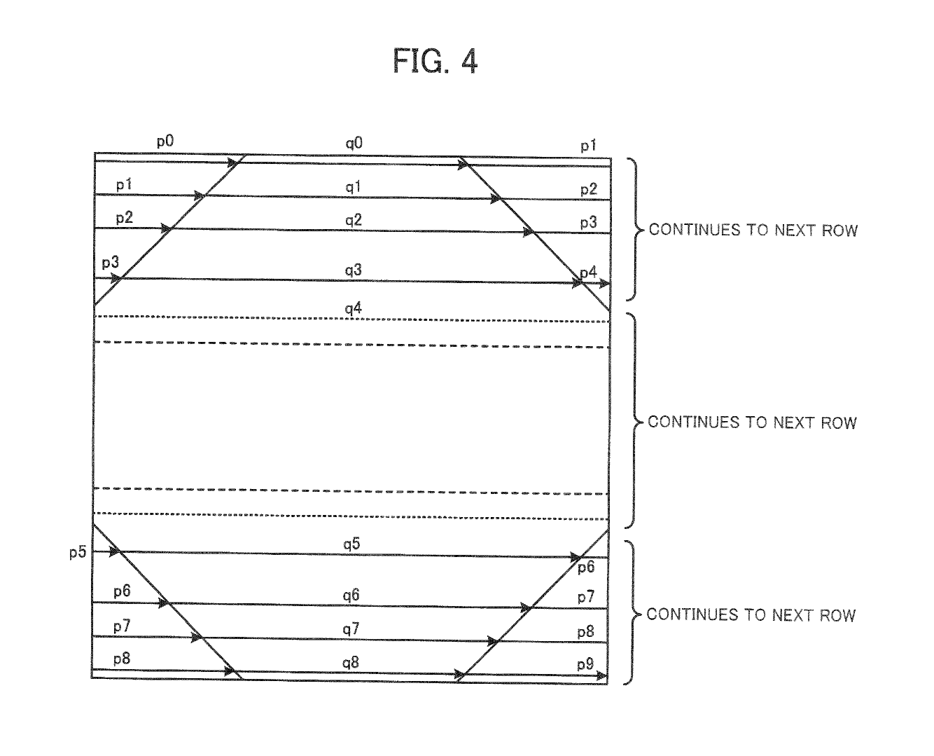

The processing target area setting section 104 sets a processing target area that is stored in advance, or sets a processing target area that has been set via the external I/F 111. The processing target area may be the area illustrated in FIG. 3A, for example. As illustrated in FIG. 3B, the processing target area is set within the imaging area (within the object image area in a narrow sense). As illustrated in FIG. 4, the processing target area that is set by the processing target area setting section 104 is stored in a run-length state in which the processing target area or an area (non-processing target area) other than the processing target area consecutively appears. In FIG. 4, p0 is the number of pixels that consecutively form the non-processing target area from the upper left pixel to the right, q0 is the number of pixels that consecutively form the processing target area from the subsequent pixel, and p1 is the number of pixels that consecutively form the non-processing target area from the subsequent pixel (e.g., the data is stored as p0 to p9 and q0 to q8). The run-length encoding method has a high data compression effect when identical data consecutively appears, and makes it possible to relatively reduce the memory area used to store the data.

Note that the processing target area setting method is not limited to the run-length encoding method. The processing target area may be stored as data that is compressed by another binary image compression method. A memory that corresponds to one pixel of the image and has a capacity equal to or more than 1 bit may be provided corresponding to each pixel, and a value that indicates the processing target area or an area (non-processing target area) other than the processing target area may be stored in each memory. A calculation process that determines whether or not each pixel corresponds to the processing target area can be made unnecessary by providing a memory corresponding to each pixel, so that the processing speed can be increased.

The grayscale transformation section 106 extracts the processing target area set by the processing target area setting section 104 from the image signal acquired area, and performs a grayscale transformation process on the image signals in the processing target area. More specifically, the grayscale transformation section 106 generates a histogram of the pixel values of the image signals in the processing target area, and performs the grayscale transformation process that smooths the histogram. The details of the grayscale transformation process are described later.

The post-processing section 107 performs image processing (e.g., color correction and edge enhancement) on the image signals that have been subjected to the grayscale transformation process by the grayscale transformation section 106. Note that the post-processing section 107 may perform image processing on the image signal acquired area instead of the processing target area.

The masking section 108 performs a masking process on the image signals in the processing target area using a mask area that is set in advance. The masking process converts the image signals in an area included in the mask area into a signal value that corresponds to black without converting the image signals in an area that is not included in the mask area. Note that the area (i.e., transmission area or display area) that is not included in the mask area is a subset of the processing target area. The area that is not included in the mask area may be identical with the processing target area. FIG. 3C illustrates an example of the mask area, and FIG. 3D illustrates the relationship between a display area and the processing target area.

The image output section 109 records (stores) the image signals subjected to the masking process in a recording medium (e.g., memory card), or outputs the image to a display section (not illustrated in the drawings).

The grayscale transformation process performed by the grayscale transformation section 106 is described in detail below with reference to FIGS. 11A to 11D. Since an area other than the processing target area mainly includes the non-imaging area, only a dark (small) pixel signal is obtained in an area other than the processing target area. As illustrated in FIG. 11A, a histogram of the entire image signal acquired area includes a number of dark pixels. The processing target area (necessary area) becomes too bright when performing the grayscale transformation process that smooths the histogram (see FIG. 11B). According to the first embodiment, a histogram of only the processing target area is generated (see FIG. 11C), and the grayscale transformation process is performed on the resulting histogram. This makes it possible to implement a grayscale transformation process within an appropriate range that prevents a situation in which the processing target area becomes too bright (see FIG. 11D).

Several noise pixels (bright pixels) may normally be present in an area other than the processing target area that mainly includes the non-imaging area (dark (small) pixel signal). Such noise is amplified by performing the grayscale transformation process on the entire image signal acquired area. According to the first embodiment, a situation in which noise present in an area other than the processing target area is amplified can be prevented by performing the grayscale transformation process on only the processing target area. When noise is present in an area other than the processing target area, an image in which noise stands out at the boundary with the mask area may be obtained if the masking section 108 performs the masking process so that the mask area does not overlap the processing target area to some extent. Note that noise is not amplified by not performing the grayscale transformation process on an area other than the processing target area. In this case, an excellent image is obtained even if the mask area is set to have a size equal to or close to that of the imaging area.

Although an example in which the process according to the first embodiment is implemented by hardware has been described above, the configuration is not limited thereto. It is possible to employ a configuration in which the process according to the first embodiment is implemented by software. Although an example in which the image sensor has a primary-color Bayer array configuration has been described above, the image sensor may utilize a complementary color or the like. Although an example in which the grayscale transformation process is an adaptive grayscale transformation process that smooths a histogram has been described above, it is also possible to employ an adaptive grayscale transformation process that utilizes human visual characteristics (local chromatic adaptation).

The grayscale transformation process that utilizes a local area is described below. The grayscale transformation section 106 performs the grayscale transformation process on the processing target area that is included in the image input from the preprocessing section 105 and has been set by the processing target area setting section 104. In this case, the grayscale transformation section 106 may divide the processing target area into a plurality of local areas. For example, the grayscale transformation section 106 may divide the image signals corresponding to the processing target area into a plurality of rectangular areas that have a given size, and may set each rectangular area as the local area. The size of each rectangular area may be appropriately set. For example, each rectangular area may include 16×16 pixels. The grayscale transformation section 106 may calculate a histogram of each local area (see FIG. 11C). The grayscale transformation section 106 may determine the characteristics of the grayscale transformation process based on the histogram of each local area, and may perform the grayscale transformation process based on the determined characteristics.

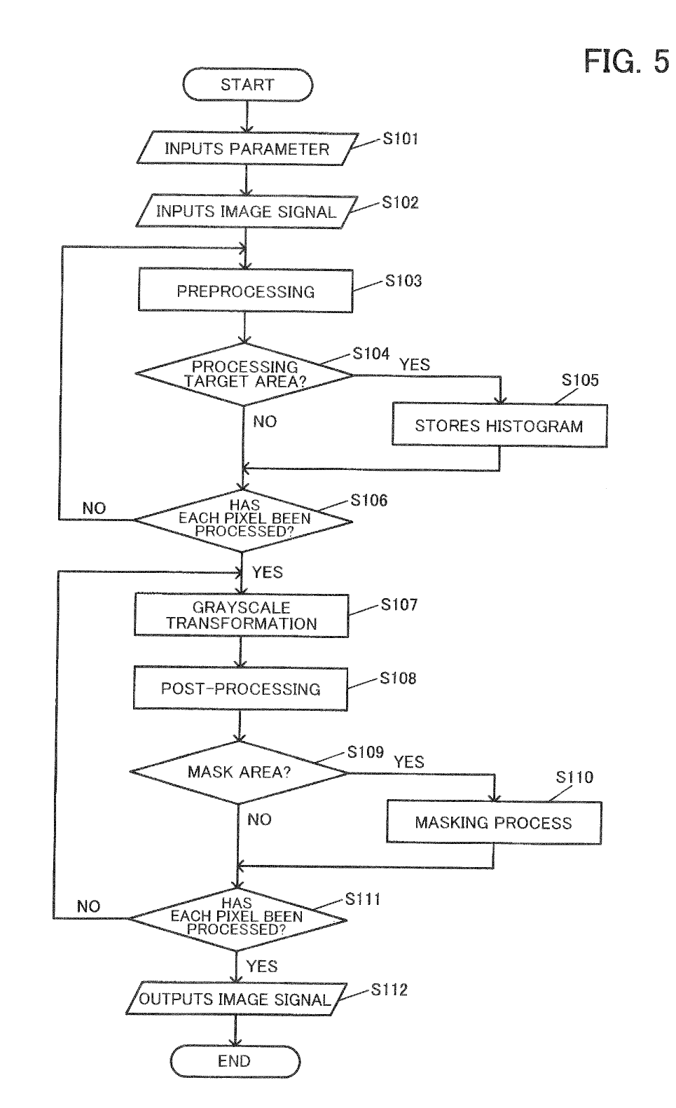

FIG. 5 illustrates the flow of a software process. In the first embodiment, part or the entirety of the process may be implemented by software. In this case, a CPU of a computer system executes an image processing program.

As illustrated in FIG. 5, parameter information (e.g., processing target area and mask area) is input in a step S101. An image is input in a step S102, and image processing (e.g., OB clamp process, gain control process, and WB correction process) is performed in a step S103. Whether or not each pixel of the image is positioned within the processing target area is determined in a step S104. The process branches from the step S104 to a step S105 (when the pixel is positioned within the processing target area) or a step S106 (when the pixel is not positioned within the processing target area). In the step S105, information about the pixel values is stored, and a histogram is generated. The process then proceeds to the step S106. In the step S106, whether or not each pixel of the input image has been processed is determined The process returns to the step S103 when each pixel of the input image has not been processed.

When it has been determined that each pixel of the input image has been processed in the step S106, the process proceeds to a step S107. In the step S107, the grayscale transformation process is performed based on the histogram stored in the step S105. Image processing (e.g., color process and contour enhancement process) is performed in a step S 108, and whether or not each pixel of the image is positioned within the mask area input in the step S101 is determined in a step S109. The process branches from the step S109 to a step S110 (when the pixel is positioned within the mask area) or a step S111 (when the pixel is not positioned within the mask area).

In the step S110, the pixel value is changed to zero or a pixel value that corresponds to black. The process then transitions to the step S111. In the step S111, whether or not each pixel of the input image has been processed is determined The process returns to the step S107 when each pixel of the input image has not been processed. When it has been determined that each pixel of the input image has been processed in the step S111, the image is output in a step S112, and the process ends.

Note that whether or not each pixel is positioned within the processing target area may be determined before the step S107, and the grayscale transformation process (step S107) and the post-process (step S108) may be performed only when the pixel is positioned within the processing target area.

According to the first embodiment, the image processing device includes the image signal acquisition section 102 that acquires the image signals, the processing target area setting section 104 that sets the processing target area, and the grayscale transformation section 106 that performs the grayscale transformation process (see FIG. 1). The image sensor 1021 is configured so that the object image is formed in the imaging area via the optical system 101, and is not formed in the non-imaging area. The image signal acquisition section 102 acquires the image signals that include the signals of the object image from the image sensor 1021. The processing target area setting section 104 sets the processing target area to an image (i.e., an image of the image signal acquired area) acquired from the image sensor 1021 so that the processing target area is included in the imaging area. The grayscale transformation section 106 performs the grayscale transformation process based on the pixel values of the pixels included in the processing target area.

Note that the term “imaging area” used herein refers to an area in which light that has passed through the optical system 101 forms an image. The imaging area normally has a circular shape corresponding to the shape of the lens included in the optical system 101 (see FIG. 2B). The image sensor normally has a rectangular shape, and the image signal acquired area corresponding to the image sensor in which the image signals can be acquired has a rectangular shape (see FIG. 2C). The term “non-imaging area” used herein refers to an area that is not included in the imaging area. The non-imaging area need not necessarily be included in the image signal acquired area. Note that the non-imaging area is not limited thereto. An area common to the imaging area and the image signal acquired area is referred to as “object image area” (see FIG. 2D).

In the first embodiment, the processing target area is set within the imaging area (within the object image area in a narrow sense). Specifically, since an area that is included in the imaging area, but is not included in the object image area is not included in the image signal acquired area that corresponds to the image sensor 1021, the image signals are not acquired in such an area. Since the processing target area is used for the grayscale transformation process, an area in which the image signals are not acquired does not contribute to the grayscale transformation process. Note that an area that is positioned outside the object image area, but is included in the imaging area may also be set as the processing target area when the grayscale transformation process is performed using part of the processing target area in which the image signals are acquired.

Note that the term “processing target area” used herein refers to an area having a size that includes at least an area (e.g., the display area illustrated in FIG. 3D) that corresponds to an image output (e.g., displayed) by the image output section 109. For example, the image signal acquired area may be divided into a plurality of local areas, and the grayscale transformation process may be performed on each local area. In this case, a local area may set within the imaging area as a result of dividing the image signal acquired area into a plurality of local areas. However, since such a local area does not have a size that includes the display area, such a local area does not fall under the term “processing target area”. The term “processing target area” used herein refers to an area that is set within the imaging area, and covers the display area.

Therefore, since the processing target area used for the grayscale transformation process can be set within the imaging area, it is possible to perform the grayscale transformation process using the pixel values of the pixels on which light that forms the object image is incident, without using the pixel values of the pixels on which light that forms the object image is not incident. The image signal acquired area that corresponds to the image sensor 1021 includes an area which is not included in the imaging area and in which light that forms the object image is not incident. Since such an area has useless pixel values (e.g., is dark due to the absence of light or contains noise), the grayscale transformation process may be impaired when using such an area. Since the grayscale transformation can be performed using useful pixel values (i.e., the pixel values of pixels on which light that forms the object image is incident) by utilizing the method according to the first embodiment, it is possible to implement an appropriate grayscale transformation process.

The image processing device may include the masking section 108 that performs the masking process that masks at least a non-processing target area other than the processing target area. The image processing device may include the image output section 109 that acquires the image subjected to the masking process by the masking section 108 as a display image.

The term “non-processing target area” used herein refers to an area other than the processing target area. Since the masking process is performed on the non-processing target area, and is desirably performed on the pixels in which the image signal is acquired, the non-processing target area is set as an area that is not included in the processing target area, but is included in the image signal acquired area. Note that the non-processing target area is not limited thereto.

The above configuration makes it possible to perform the masking process that masks the non-processing target area, and acquire the image subjected to the masking process. Note that the term “masking process” used herein refers to a process that fills in an image (e.g., replaces the pixels of an image with a black pixel). Accordingly, an area that has not been subjected to the masking process corresponds to the display area illustrated in FIG. 3D. Since the processing target area is set within the imaging area, the non-processing target area basically corresponds to the non-imaging area. Note that an area that corresponds to the non-processing target area and the imaging area is also present. However, since the grayscale transformation process can be performed using a larger number of pixel values by bringing the size of the processing target area closer to that of the imaging area (object image area), it is considered that the imaging area included in the non-processing target area is small. Therefore, an area that is included in the image signal acquired area and corresponds to the non-imaging area can be masked by masking the non-processing target area, so that useless pixel values (i.e., the pixel values of pixels on which light that forms the object image is not incident) can be filled in (e.g., replaced with a black pixel value).

The image output section 109 may acquire the image subjected to the masking process that excludes the mask area that is an area masked by the masking process.

In this case, since it is unnecessary to acquire the image of the masked area, the amount of data can be reduced, for example. The masked area is an area that is blacked out, for example, and does not provide the user with information. Since it is not advantageous to acquire such a black image, the image output section 109 may acquire the image that excludes the black area (e.g., an octagonal image illustrated in FIG. 3D that corresponds to the display area).

The masking section 108 may set an area that includes the non-processing target area and a peripheral area of the processing target area as the mask area.

This makes it possible to provide the display area with a margin (see FIG. 3D). In the example illustrated in FIGS. 3A to 3D, the processing target area is set to be narrower than the object image area (i.e., is provided with a margin). If the processing target area is not set to be narrower than the object image area, the non-imaging area may be adjacent to the processing target area. It is very likely that the non-imaging area contains noise, and such noise may have been enhanced by the grayscale transformation process. Specifically, when performing the masking process on only the non-processing target area, noise that is present in the boundary area with the processing target area may be included in the display area, and may stand out. A situation in which noise stands out can be prevented by providing the display area with a margin.

The grayscale transformation section 106 may set a plurality of local areas to the image, and may perform the grayscale transformation process (e.g., adaptive grayscale transformation process) based on the plurality of local areas.

This makes it possible to implement a space-variant grayscale transformation process. When the image includes an area having relatively small pixel values and an area having relatively large pixel values, an intermediate grayscale transformation process is performed on the entire image when the local areas are not set. It is possible to implement a grayscale transformation process that reflects the features of each area by setting the local areas.

The grayscale transformation section 106 may perform a process that smooths a histogram of the pixel values in the processing target area.

This makes it possible to implement the process illustrated in FIGS. 11C and 11D. A small pixel value is increased, and a large pixel value is decreased by smoothing the histogram of the pixel values in the entire processing target area.

The processing target area setting section 104 may set the processing target area using section information that specifies a first pixel position and a second pixel position, the first pixel position being a pixel position that corresponds to a starting point of the processing target area in each row of the image of the image signal acquired area, and the second pixel position being a pixel position that corresponds to an end point of the processing target area in each row of the image of the image signal acquired area. The section information may be information that indicates the number of pixels from the starting point to the end point.

This makes it possible to implement the process illustrated in FIG. 4. The information about the processing target area may be stored by assigning “1” to a pixel that corresponds to the processing target area, and assigning “0” to a pixel that corresponds to the non-processing target area (described later). It is considered that each of the processing target area and the non-processing target area is formed by a certain number of consecutive pixels. Specifically, a certain number of pixels in one row consecutively form the processing target area. Therefore, it is possible to store the information about the processing target area with a reduced data size by storing the information about the starting point and the end point. More specifically, the information about the starting point and the end point may be information that indicates the number of pixels from the starting point to the end point. For example, the run-length encoding method stores information “AAAAABBBCCCC” as “A5B3C4”. Since it is necessary to distinguish only the processing target area and the non-processing target area, it suffices to store only a numerical value that indicates the number of pixels from the starting point to the end point.

The processing target area setting section 104 may set the processing target area based on processing target area determination information set to each pixel of the image.

This makes it possible to express the processing target area using the processing target area determination information set to each pixel. This configuration may be implemented by assigning “1” to a pixel that corresponds to the processing target area, and assigning “0” to a pixel that corresponds to the non-processing target area. In this case, the data size increases as compared with a method that utilizes the section information or polar coordinates (described later). However, it is possible to easily determine whether or not the target pixel is included in the processing target area. For example, since only the number of pixels from the starting point to the end point is stored when using the section information, it is necessary to calculate how many pixels are present between the upper left pixel and the target pixel, and compare the calculation result with the number of pixels indicated by the section information. It is possible to determine whether or not the target pixel is included in the processing target area by merely referring to the processing target area determination information set to the target pixel when storing the processing target area determination information set to each pixel.

The optical system may have an angle of view equal to or greater than 180°.

This makes it possible to utilize an imaging optical system having a high angle of view. For example, when using the optical system for endoscopic applications, it is possible to effectively search for a lesion area that is positioned on the hidden side of the folds of the large intestine or the like.

The optical system may be an optical system that can image a capture target area that is set in a front area or a side area, the front area being an area that includes the optical axis of the optical system, and the side area being an area that includes an axis that is orthogonal to the optical axis of the optical system.

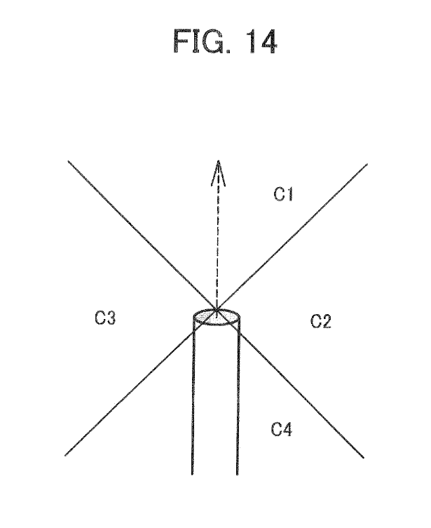

The front area and the side area are defined as illustrated in FIG. 14. The arrow illustrated in FIG. 14 indicates the optical axis, C1 indicates the front area, and C2 and C3 indicate the side area. The front area and the side area that are drawn as a planar area in FIG. 14 may be a three-dimensional area.

According to the above configuration, since the imaging area can be set in the front area and the side area, it is possible to image a wide area.

The optical system may be an optical system that can image a capture target area that is set in a rear area, the rear area being an area that includes an axis in a direction opposite to the direction of the optical axis of the optical system.

The rear area is defined as illustrated in FIG. 14 (see C4). The rear area may be a three-dimensional area.

This makes it possible to also set the imaging area in the rear area. Since a wider range can be imaged, it is possible to efficiently search for a lesion area by utilizing the optical system for endoscopic applications.

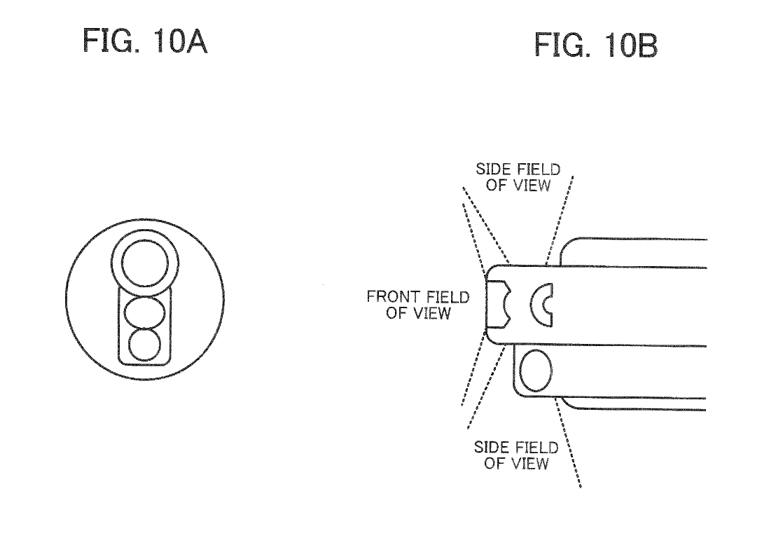

The image signal acquisition section 102 may acquire the image signals in which the non-imaging area occurs due to a blind spot caused by an obstacle that obstructs part of the field-of-view range of the optical system. As illustrated in FIGS. 10A and 10B, the optical system may be provided on the end of an insertion section of an endoscope apparatus, and the obstacle may be an opening of a tube formed on the end of the insertion section of the endoscope apparatus. Note that FIG. 10A is a front view illustrating the end of the insertion section, and FIG. 10B is a side view illustrating the end of the insertion section.

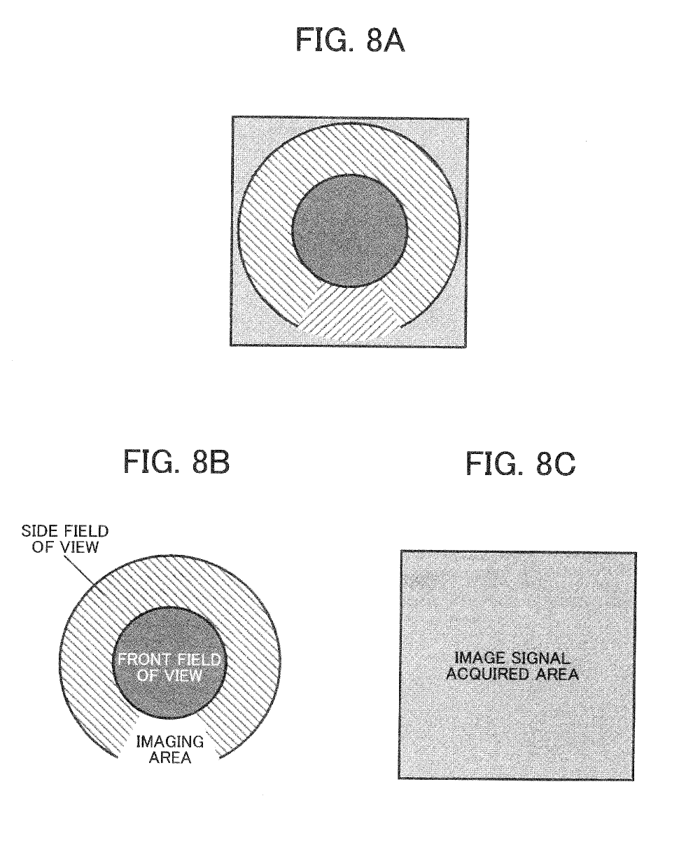

This makes it possible for the image signal acquisition section 102 to acquire an image as illustrated in FIGS. 8A and 8B. When using an endoscope apparatus that includes an optical system that can image the front field of view and the side field of view, a tube into which a forceps or the like is inserted (or an air/water supply tube) may obstruct the optical system when imaging the side field of view. In this case, it is impossible to acquire a 360-degree image that corresponds to the side field of view (i.e., a missing area occurs as illustrated in FIG. 8B). Therefore, it is necessary to appropriately set the processing target area so that the processing target area does not include such a missing area.

The first embodiment also relates to a program that causes a computer to function as the image signal acquisition section 102 that acquires an image signal, the processing target area setting section 104 that sets the processing target area, and the grayscale transformation section 106 that performs the grayscale transformation process. The image sensor 1021 is configured so that the object image is formed in the imaging area via the optical system 101, and is not formed in the non-imaging area. The image signal acquisition section 102 acquires the image signals that include the signals of the object image from the image sensor 1021. The processing target area setting section 104 sets the processing target area to an image (i.e., an image of the image signal acquired area) acquired from the image sensor 1021 so that the processing target area is included in the imaging area. The grayscale transformation section 106 performs the grayscale transformation process based on the pixel values of the pixels included in the processing target area.

This makes it possible to implement the above process using a program (software). For example, it is possible to collectively acquire image signals in advance, and process the image signals later (i.e., capsule endoscope). The program is stored in an information storage device. The information storage device may be an arbitrary recording device that is readable by an information processing device or the like, such as an optical disk (e.g., DVD and CD), a magnetooptical disk, a hard disk (HDD), and a memory (e.g., nonvolatile memory and RAM). For example, the program may be stored in an arbitrary recording device that is readable by a PC or the like, and may be executed by a processing section (e.g., CPU) of the PC or the like.

### 3. Second Embodiment

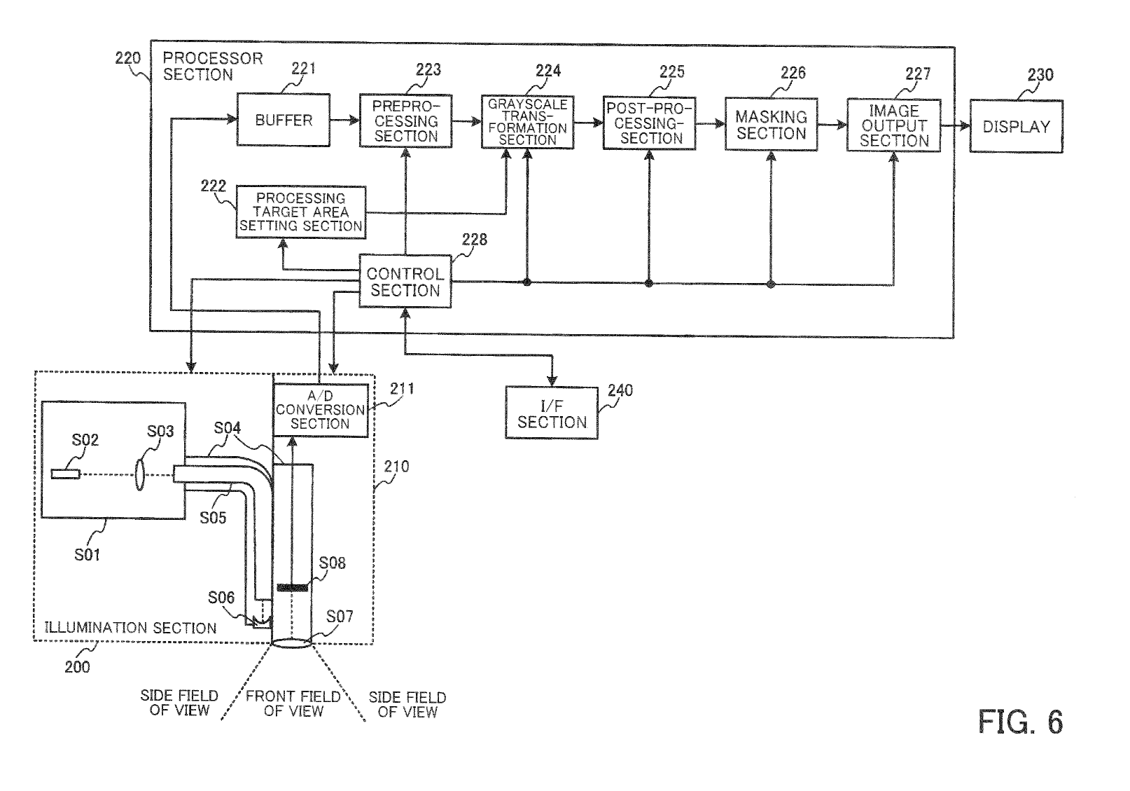

FIG. 6 illustrates a configuration example of an endoscope apparatus that includes an image processing device according to the second embodiment. The endoscope apparatus illustrated in FIG. 6 includes an illumination section 200, an imaging section 210, a processor section 220, a display 230, and an I/F section 240. An image output from an image output section 227 is displayed on the display 230, differing from the first embodiment.

The illumination section 200 includes a light source device S01 that includes a white light source S02 and a condenser lens S03, a light guide fiber S05, and an illumination optical system S06. The imaging section 210 includes a condenser lens S07, an image sensor S08, and an A/D conversion section 211.

The processor section 220 corresponds to the image processing device according to the first embodiment illustrated in FIG. 1. The processor section 220 includes a buffer 221, a processing target area setting section 222, a preprocessing section 223, a grayscale transformation section 224, a post-processing section 225, a masking section 226, the image output section 227, and a control section 228. The control section 228 includes a microcomputer, a CPU, and the like. The I/F section 240 includes a power switch, a variable setting interface, and the like.

The white light source S02 emits white light. The white light reaches the condenser lens S03, and is condensed by the condenser lens S03. The condensed white light passes through the light guide fiber S05, and is applied to the object from the illumination optical system S06. Reflected light from the object is condensed by the condenser lens S07, and reaches the image sensor S08 in which color filters that respectively allow R, G, or B light to pass through are disposed in a Bayer array. The image sensor S08 performs a photoelectric conversion process to generate an analog signal, and transmits the analog signal to the A/D conversion section 211. The A/D conversion section 211 converts the analog signal into a digital signal, and stores the digital signal in the buffer 221 as an image.

The condenser lens S07 protrudes from the end of the insertion section, and utilizes a lens that has an angle of view of 230° (i.e., the front area and the side area can be observed). As illustrated in FIG. 10A, a lens, an illumination section, and a forceps opening for providing a treatment tool or supplying water/air are provided at the end of the imaging section. As illustrated in FIG. 10B, it is necessary to dispose an illumination section on the side of the insertion section at a position around the end of the insertion section in order to apply light to the side field of view. A treatment tool (e.g., forceps) is used, or water/air is supplied when performing treatment or biopsy in a state in which the endoscope is inserted into a body. Therefore, it is necessary to provide a path for the treatment tool. Therefore, it is necessary to dispose a covering at a position that overlaps the side field of view. As a result, a side field of view of 360° cannot be obtained (i.e., a missing area occurs) (see FIGS. 8A to 8C).

Only useless data is obtained from the missing area in the image signal acquired area. The useless data is reflected in the grayscale transformation process when the grayscale transformation process is performed based on the front field of view and the entire side field of view (360°). In order to deal with this problem, the processing target area setting section 222 sets the processing target area so that the missing area is excluded from the processing target area.

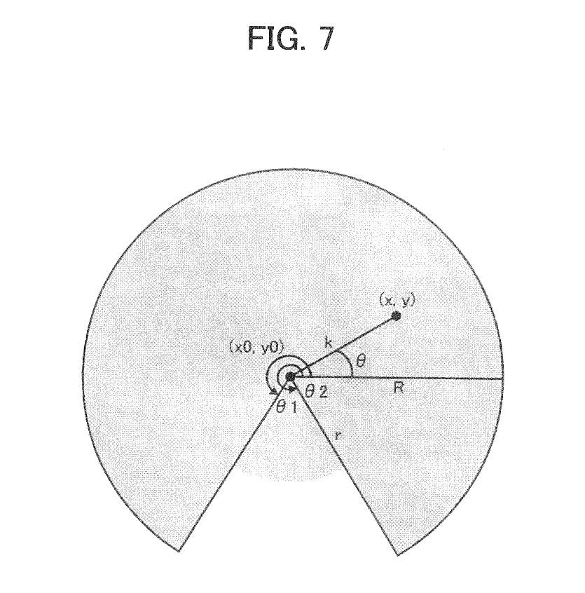

The processing target area is stored using the polar coordinates illustrated in FIG. 7. The center coordinates (x0, y0) and the radius R may be stored in advance. k and θ shown by the following expressions (1) and (2) are stored as the coordinates (x, y) of each pixel.

$$\begin{matrix}k = \sqrt{{( x - x 0 )}^{2} + {( y - y 0 )}^{2}} & ( 1 ) \\ θ = tan ( \frac{y}{x} ) & ( 2 )\end{matrix}$$

When a function that indicates the boundary between the processing target area and an area other than the processing target area is indicated by f(θ), an area other than the processing target area is calculated by the following expression (3).

f(θ)>k (3)

In particular, when the missing area is fan-shaped, it is possible to simply express the processing target area. When the radius of the front field of view is r, and the angle of the missing side field of view is θ1 to θ2, the processing target area is calculated by the following expression (4).

k<r or (r<k≦R and (θ≦θ1 or θ2≦θ)) (4)

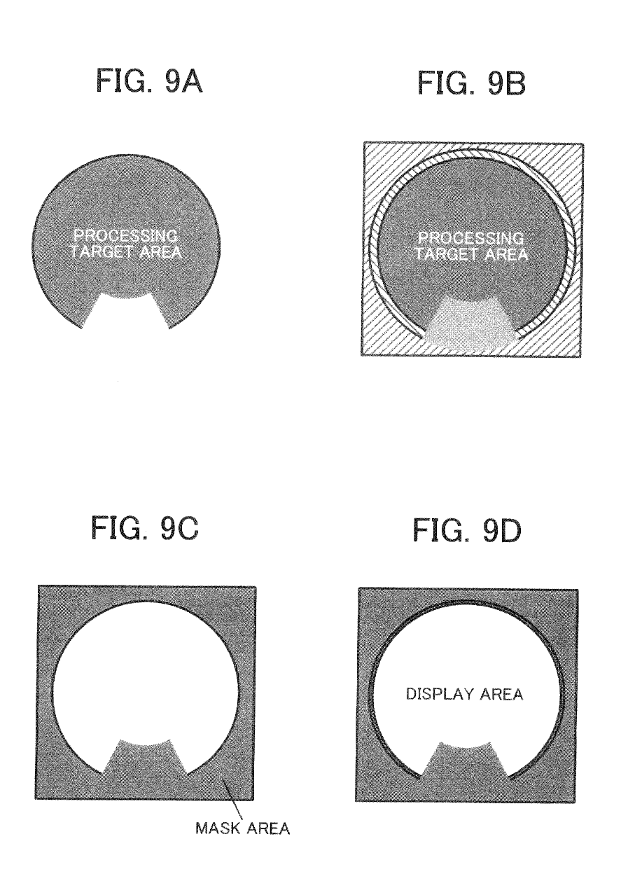

The process after the processing target area has been set is the same as described above in connection with the first embodiment. Therefore, detailed description thereof is omitted. The relationship between the processing target area, the mask area, and the display area is also the same as described above in connection with the first embodiment (see FIGS. 9A to 9D). The process performed by the processor section 220 according to the second embodiment may also be implemented by software. In this case, the process is implemented in the same way as illustrated in the flowchart illustrated in FIG. 5. Therefore, detailed description thereof is omitted.

According to the second embodiment, the processing target area setting section 222 may set the processing target area based on the distance from the center coordinates of the image of the imaging area within the image of the image signal acquired area.

This makes it possible to store the information about the processing target area using the polar coordinates (see the expressions (1) to (4)). When setting a circular (or similar) processing target area, differing from the first embodiment in which the processing target area is set to have an octagonal shape, it is possible to easily express the processing target area by setting the processing target area using the polar coordinates.

The processing target area setting section 222 may change the distance from the center coordinates based on an angle with respect to a reference direction that is set to the center coordinates. In particular, when the non-imaging area occurs due to a blind spot caused by an obstacle that obstructs part of the field-of-view range of the optical system, the processing target area setting section 222 may set the distance at the angle that corresponds to the direction in which the obstacle is present to be shorter than the distance at the angle that corresponds to the direction in which the obstacle is not present.

This makes it possible to change the distance in the polar coordinate system corresponding to the angle. Therefore, it is possible to express the processing target area having an arbitrary shape using the polar coordinates. Note that an advantage obtained by expressing a shape that significantly differs from a circle using the polar coordinates is small taking account of the processing load and the like. On the other hand, a significant advantage is obtained by expressing a shape similar to a circle using the polar coordinates when using an optical system that images the front area and the side area (see FIG. 9A), for example. In particular, when the missing area is fan-shaped, it is possible to simply express the processing target area (see the expression (4)).

The second embodiment also relates to an endoscope apparatus that includes the image signal acquisition section (imaging section 210) that acquires the image signals, the processing target area setting section 222 that sets the processing target area, and the grayscale transformation section 224 that performs the grayscale transformation process (see FIG. 6). The image sensor S08 is configured so that the object image is formed in the imaging area via the optical system (illumination section 200), and is not formed in the non-imaging area. The image signal acquisition section acquires the image signals that include the signals of the object image from the image sensor S08. The processing target area setting section 222 sets the processing target area to an image (i.e., an image of the image signal acquired area) acquired from the image sensor S08 so that the processing target area is included in the imaging area. The grayscale transformation section 224 performs the grayscale transformation process based on the pixel values of the pixels included in the processing target area.

This makes it possible to implement an endoscope apparatus that can perform the above process. An image acquired by the endoscope apparatus may be an in vivo image that is normally used to observe and find a lesion area or the like. A lesion area may be missed when blown out highlights or the like have occurred due to an inappropriate grayscale transformation process. Therefore, it is particularly important for the endoscope apparatus to set the processing target area and appropriately perform the grayscale transformation process.

The image signal acquisition section (imaging section 210) may acquire the image signals in which the non-imaging area occurs due to a blind spot caused by an obstacle that obstructs part of the field-of-view range of the optical system.

This makes it possible for the endoscope apparatus to appropriately set the processing target area to the image acquired from the image signals in which part of the field of view is missing. Since the endoscope apparatus is also used to perform treatment using a tool in addition to observing a lesion area, a forceps tube (see FIG. 10B) or the like obstructs the optical system when imaging the side field of view. Therefore, it is necessary to appropriately set the processing target area.

### 4. Third Embodiment

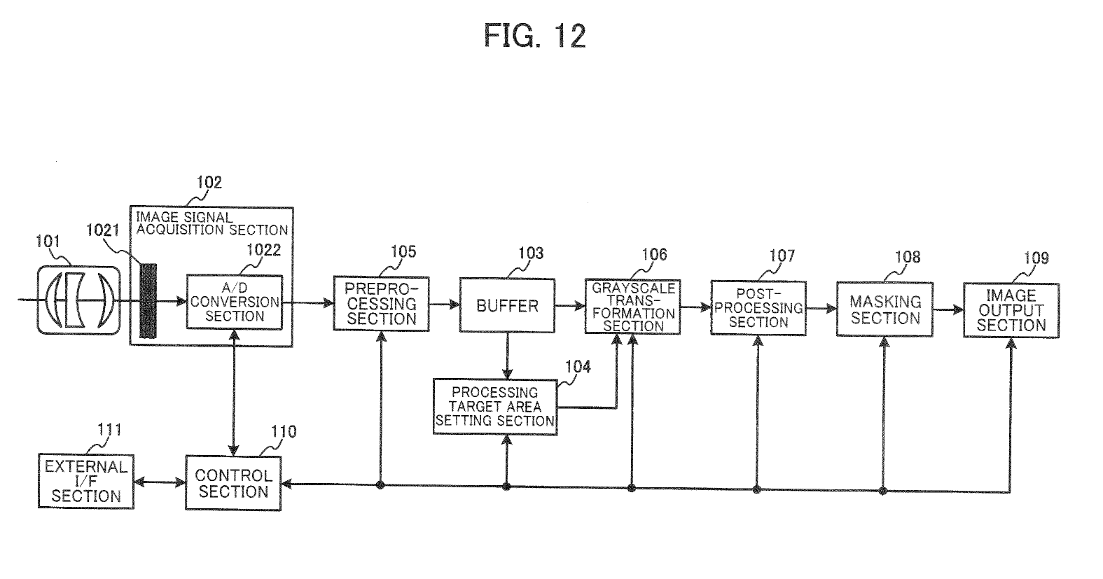

FIG. 12 illustrates a configuration example of an image processing device according to the third embodiment. The image processing device according to the third embodiment differs from the image processing device according to the first embodiment (see FIG. 1) in that the A/D conversion section 1022 is connected to the preprocessing section 105, and the preprocessing section 105 is connected to the buffer 103. The buffer 103 is also connected to the processing target area setting section 104 and the grayscale transformation section 106.

In the third embodiment, the image signal acquisition section 102 operates in a reference image acquisition mode or a normal operation mode. The operation mode is switched by pressing a reference image acquisition button included in the external I/F section 111. The operation mode is set to the normal operation mode (initial mode) until the reference image acquisition button is pressed. When the user has pressed the reference image acquisition button, the operation mode is switched to the reference image acquisition mode, and the image signals output from the preprocessing section 105 are stored in the buffer 103 as a reference image. The processing target area setting section 104 sets the processing target area based on the reference image stored in the buffer 103. When the processing target area setting section 104 has set the processing target area, the operation mode is automatically switched to the normal operation mode, and the grayscale transformation section 106 performs the grayscale transformation process on the input image signals based on the processing target area set by the processing target area setting section 104. When the user has again pressed the reference image acquisition button, the image signals output from the preprocessing section 105 are acquired, and overwritten into the buffer 103 as the reference image.

The reference image acquisition mode is described in detail below. The reference image is a white balance image obtained by capturing a white balance cap (white object), for example. In this case, the user covers the end of the optical system 101 with the white balance cap, and presses the reference image acquisition button. The white balance cap has almost uniform spectral reflectivity within the visible region. The white balance image is used to calculate a white balance coefficient. The white balance coefficient is a coefficient by which the R signal and the B signal are multiplied so that R, G, and B of the image signals respectively become equal when capturing a white object.

When the user has pressed the reference image acquisition button, the white balance image output from the image signal acquisition section 102 is stored in the buffer 103 as the reference image.

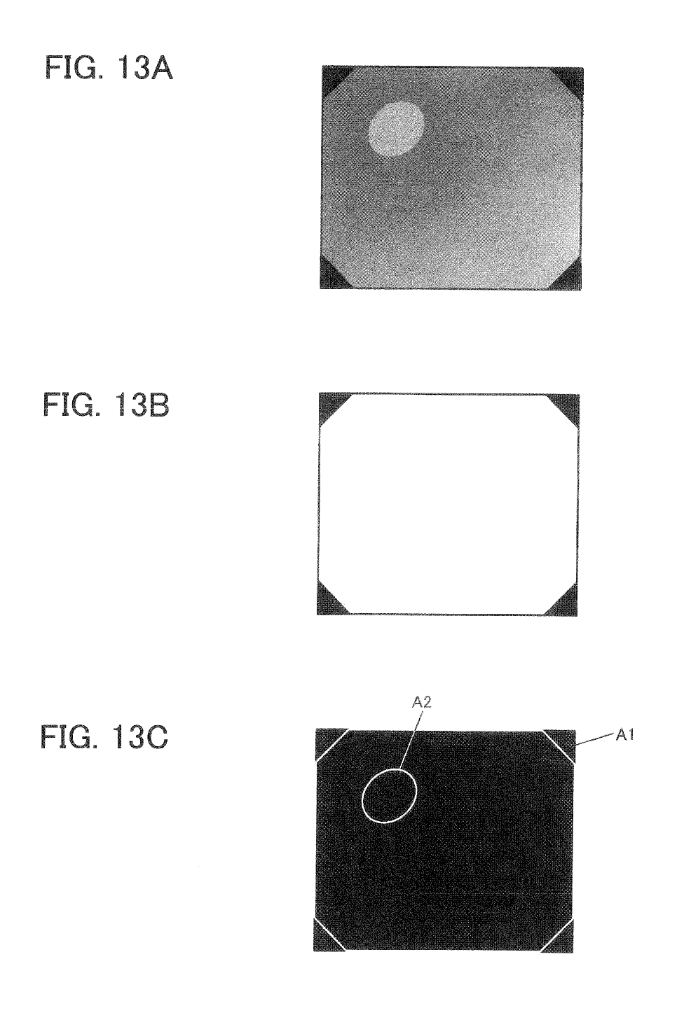

The processing target area setting section 104 sets the processing target area to the image signals based on the reference image stored in the buffer 103. More specifically, the processing target area setting section 104 binarizes the reference image based on a given threshold value, and sets the processing target area based on the binarized reference image. For example, the reference image is a color image that has an R channel, a G channel, and a B channel. The processing target area setting section 104 compares the signal value of the G signal of the reference image (FIG. 13A) with the given threshold value, and sets pixels in which the signal value of the G signal is equal to or larger than the given threshold value as the processing target area (FIG. 13B). Note that the processing target area setting section 104 may set pixels in which the signal value of the luminance signal of the reference image is equal to or larger than a given threshold value as the processing target area.

As a modification, the processing target area setting section 104 may detect an edge of the reference image, and may set the processing target area based on the detected edge of the reference image. For example, the processing target area setting section 104 may perform a filtering process on the G signal of the reference image using a known Laplacian filter, and may detect pixels for which the result of the filtering process is equal to or larger than a given threshold value as an edge (see FIG. 13C). Note that the processing target area setting section 104 may perform the filtering process on the luminance signal of the reference image. The processing target area setting section 104 may detect an edge using a known edge detection process (e.g., Canny edge detection process).

However, an edge other than the detection target edge (A1) may be detected (see A2 in FIG. 13C) due to the shape of the cap and the like. In this case, the detected edge is labeled by a known labeling process, and whether or not each labeled edge forms a closed area is determined When the labeled edge forms a closed area, the area of the closed area is acquired. When the maximum area of the closed area is equal to or larger than a given threshold value, the closed area is set as the processing target area. The processing target area is not set when an edge that forms a closed area is not present, or when the maximum area of the closed area is less than the given threshold value, the user is notified that the processing target area could not be set. When the processing target area could not be set, the processing target area stored in advance may be set in the same manner as in the first embodiment.

The normal operation mode is described below. In the normal operation mode, the process subsequent to the process performed by the preprocessing section 105 is performed in the same manner as in the first embodiment. When the processing target area has not been set by the processing target area setting section 104, the grayscale transformation section 106 performs the grayscale transformation process on each image signal.

The subsequent process is the same as described above in connection with the first embodiment. Therefore, detailed description thereof is omitted.

According to the third embodiment, the processing target area setting section 104 may set the processing target area based on the reference image that has been acquired by the image signal acquisition section 102.

This makes it possible to cancel a process variation of the optical system and the like. The size of the imaging area and the size of the image signal acquired area (size of the image sensor) can be determined based on the design. If the optical system and the like are produced in conformity with the design, the processing target area can be determined in advance based on the design. However, there may be a case where the processing target area set in advance is inappropriate due to a process variation and the like. It is possible to deal with such a case by acquiring the reference image, and setting the processing target area based on the acquired reference image.

The image signal acquisition section 102 may acquire an image obtained by capturing a given chart as the reference image. The image obtained by capturing a given chart may be an image (white balance image) obtained by capturing a chart that has spectral reflectivity that specifies white with respect to illumination light.

Note that the term “chart” used herein refers to a color chart. Specifically, the chart is a color reference. For example, a white chart is a reference that makes it possible to adjust the degree of white by setting the chart so that the pixel value becomes a maximum when capturing the chart.

This makes it possible to use an image obtained by capturing a given chart as the reference image. For example, a white balance image acquired in state in which a white cap fitted to the imaging section may be used. In this case, since a white image is obtained within an attainable light range, an area that should be set as the processing target area can be determined by distinguishing from a dark area due to the absence of light.

The processing target area setting section 104 may set an area in which the pixel value of the reference image is equal to or larger than a given threshold value as the processing target area.

This makes it possible to set the processing target area by performing a determination process using a threshold value. Specifically, the processing target area (white area) can be set (see FIG. 13B) by performing a determination process on the image illustrated in FIG. 13A using a threshold value.

The processing target area setting section 104 may perform an edge detection process based on the pixel value of the reference image, and may set the processing target area based on a detected edge.

This makes it possible to set the processing target area by performing the edge detection process. When the image illustrated in FIG. 13A is obtained, an edge formed by a relatively bright area (i.e., an area on which light is incident) and a dark area can be detected. The detected edge may be determined to be the boundary between the processing target area and the non-processing target area. Since the white balance image is captured in a state in which a cap fitted to the imaging section, light and shade may occur due to the shape of the cap (see FIG. 13A), and an edge due to the shape of the cap may be detected (see A2 in FIG. 13C). In this case, an edge that forms a closed area may be detected, and a closed area having an area that is a maximum and is equal to or larger than a threshold value may be selected. In FIG. 13C, the edge A1 and the edge A2 are detected, and the edge Al is used as the boundary of the processing target area.

The first to third embodiments according to the invention and the modifications thereof have been described above. Note that the invention is not limited to the first to third embodiments and the modifications thereof. Various modifications and variations may be made without departing from the scope of the invention. A plurality of elements described in connection with the first to third embodiments and the modifications thereof may be appropriately combined to achieve various configurations. For example, an arbitrary element may be omitted from the elements described in connection with the first to third embodiments and the modifications thereof. Some of the elements disclosed in connection with different embodiments or modifications thereof may be appropriately combined. Specifically, various modifications and applications are possible without materially departing from the novel teachings and advantages of the invention.

What is claimed is:

1. An image processing device comprising:
an image signal acquisition section that acquires image signals that include signals of an object image from an image sensor, the image sensor being configured so that the object image is formed in an imaging area via an optical system, and is not formed in a non-imaging area;
a processing target area setting section that sets a processing target area to an image of an image signal acquired area so that the processing target area is included in the imaging area, the image signal acquired area being an area in which the image signals have been acquired, and the processing target area including pixels used for a grayscale transformation process; and
a grayscale transformation section that performs the grayscale transformation process based on pixel values of the pixels included in the processing target area.

2. The image processing device as defined in claim 1, further comprising:
a masking section that performs a masking process that masks at least a non-processing target area that is an area other than the processing target area.

3. The image processing device as defined in claim 2, further comprising:
an image output section that outputs an image subjected to the masking process by the masking section as a display image that is displayed on a display section.

4. The image processing device as defined in claim 3,
the image output section outputting the image of the image signal acquired area that has been subjected to the masking process and excludes a mask area as the display image that is displayed on the display section, the mask area being an area masked by the masking process.

5. The image processing device as defined in claim 3,
the masking section setting an area that includes the non-processing target area and a peripheral area of the processing target area as the mask area that is masked by the masking process.

6. The image processing device as defined in claim 1,
the grayscale transformation section setting a plurality of local areas to the image of the image signal acquired area or an image of the processing target area, and performing the grayscale transformation process based on each of the plurality of local areas.

7. The image processing device as defined in claim 1,
the grayscale transformation section performing a process that smooths a histogram of the pixel values of the pixels included in the processing target area as the grayscale transformation process.

8. The image processing device as defined in claim 1,
the processing target area setting section setting the processing target area using section information that specifies a first pixel position and a second pixel position, the first pixel position being a pixel position that corresponds to a starting point of the processing target area in each row of an image of the image signal acquired area, and the second pixel position being a pixel position that corresponds to an end point of the processing target area in each row of the image of the image signal acquired area.

9. The image processing device as defined in claim 8,
the section information being information that indicates a number of pixels from the first pixel position that corresponds to the starting point to the second pixel position that corresponds to the end point.

10. The image processing device as defined in claim 1,
the processing target area setting section setting the processing target area based on a distance from center coordinates of an image of the imaging area within an image of the image signal acquired area.

11. The image processing device as defined in claim 10,
the processing target area setting section changing the distance from the center coordinates based on an angle with respect to a reference direction that is set to the center coordinates.

12. The image processing device as defined in claim 11,
the processing target area setting section setting the distance at the angle that corresponds to a direction in which an obstacle is present to be shorter than the distance at the angle that corresponds to a direction in which the obstacle is not present, when the non-imaging area occurs due to a blind spot caused by the obstacle that obstructs part of a field-of-view range of the optical system.

13. The image processing device as defined in claim 1,
the processing target area setting section setting the processing target area based on processing target area determination information set to each pixel of the image of the image signal acquired area.

14. The image processing device as defined in claim 1,
the processing target area setting section setting the processing target area based on a reference image that has been acquired by the image signal acquisition section.

15. The image processing device as defined in claim 14,
the image signal acquisition section acquiring an image obtained by capturing a given chart as the reference image.

16. The image processing device as defined in claim 15,
the image signal acquisition section acquiring an image obtained by capturing the chart that has spectral reflectivity that specifies white with respect to illumination light as the reference image.

17. The image processing device as defined in claim 14,
the processing target area setting section setting an area in which a pixel value of the reference image is equal to or larger than a given threshold value as the processing target area.

18. The image processing device as defined in claim 14,
the processing target area setting section performing an edge detection process based on a pixel value of the reference image, and setting the processing target area based on an edge detected by the edge detection process.

19. The image processing device as defined in claim 1,
the optical system having an angle of view equal to or greater than 180°.

20. The image processing device as defined in claim 1,
the optical system being an optical system that can image a capture target area that is set in a front area or a side area, the front area being an area that includes an optical axis of the optical system, and the side area being an area that includes an axis that is orthogonal to the optical axis of the optical system.

21. The image processing device as defined in claim 20,
the optical system being an optical system that can image a capture target area that is set in a rear area, the rear area being an area that includes an axis in a direction opposite to a direction of the optical axis of the optical system.

22. The image processing device as defined in claim 1,
the image signal acquisition section acquiring the image signals in which the non-imaging area occurs due to a blind spot caused by an obstacle that obstructs part of a field-of-view range of the optical system.

23. The image processing device as defined in claim 22,
the optical system being provided on an end of an insertion section of an endoscope apparatus, and
the obstacle being an opening of a tube formed on the end of the insertion section of the endoscope apparatus.

24. An endoscope apparatus comprising:
an image signal acquisition section that acquires image signals that include signals of an object image from an image sensor, the image sensor being configured so that the object image is formed in an imaging area via an optical system, and is not formed in a non-imaging area;
a processing target area setting section that sets a processing target area to an image of an image signal acquired area so that the processing target area is included in the imaging area, the image signal acquired area being an area in which the image signals have been acquired, and the processing target area including pixels used for a grayscale transformation process; and
a grayscale transformation section that performs the grayscale transformation process based on pixel values of the pixels included in the processing target area.

25. The endoscope apparatus as defined in claim 24,
the image signal acquisition section acquiring the image signals in which the non-imaging area occurs due to a blind spot caused by an obstacle that obstructs part of a field-of-view range of the optical system.

26. An information storage device storing a program that causes a computer to function as:
an image signal acquisition section that acquires image signals that include signals of an object image from an image sensor, the image sensor being configured so that the object image is formed in an imaging area via an optical system, and is not formed in a non-imaging area;
a processing target area setting section that sets a processing target area to an image of an image signal acquired area so that the processing target area is included in the imaging area, the image signal acquired area being an area in which the image signals have been acquired, and the processing target area including pixels used for a grayscale transformation process; and
a grayscale transformation section that performs the grayscale transformation process based on pixel values of the pixels included in the processing target area.

27. An image processing method comprising:
acquiring image signals that include signals of an object image from an image sensor, the image sensor being configured so that the object image is formed in an imaging area via an optical system, and is not formed in a non-imaging area;
setting a processing target area to an image of an image signal acquired area so that the processing target area is included in the imaging area, the image signal acquired area being an area in which the image signals have been acquired, and the processing target area including pixels used for a grayscale transformation process; and
performing the grayscale transformation process based on pixel values of the pixels included in the processing target area.
